(19) United States
(12) Patent Application Publication
(10) Pub. No.: US 2003/0167344 A1
(43) Pub. Date: Sep. 4, 2003

(54) Method for building and working a multifunctional communication system and a system obtained according to said method

(76) Inventor: M. Abdulai Danso, Aulnay Sous Bois (FR)

Correspondence Address: Niro, Scavone, Haller & Niro, Suite 4600, 181 W. Madison, Chicago, IL, 60602, US

(21) Appl. No.: 10/234,779

(22) Filed: Sep. 4, 2002

(30) Foreign Application Priority Data
Mar. 1, 2002 (FR) 02 02801

(51) Int. Cl. G06F 15/16

(52) U.S. Cl. 709/249; 709/204

(57) ABSTRACT

A method and apparatus for implementing a multifunctional communication system which may be used in a large number of applications including remote classrooms and Internet trade. The method includes a parent pyramid structure formed of a multiple of validated communication networks. Each communication network has a planetary network comprising a predetermined number of communication nodes. Additionally, there exists an exchange and communication protocol between the various communication nodes that permits the various communication nodes to communicate.

The present invention concerns a method for embodying and implementing a multifunctional communication system able to used in a large number of applications such as, for example, remote-aided learning or even trade on the Internet network or the like. It also concerns a communication system obtained by said method.

Generally speaking, there already exist a large number of organisations using pyramidal structures.

Said organisations are set up by a creative central entity (level 0) which recruits a series of affiliated entities of lower level (level 1) which each in turn recruit a series of entities of level 2.

This chain recruitment method, which theoretically can be repeated indefinitely, leads to obtaining a pyramidal type structure having all its links converging towards the creative central entity.

In this type of structure, each secondary entity can regardless of its level set up its own pyramidal structure inside the mother structure and in turn become the top of this new partial structure.

All the pyramidal structures set up are based inside the parent pyramid so that the entities composing them converge towards said creative central entity.

It has been proved that such a group quickly becomes very complex and impossible to manage. In addition to this problem, there is the fact that a large number of defections generally occur at various levels of the pyramids and that very quickly many entities, indeed even the secondary pyramidal structures, become isolated and can no longer communicate with the structures and/or entities situated upstream.

Moreover, so as to urge the entities to develop the network, these organisations anticipate paying each body by instalments made by the affiliated entities situated at lower levels, most frequently by the new affiliated entities situated at the base of the pyramid.

As cumulated data, the overall remuneration of an entity depends on the affiliated number of entities situated at lower levels; at a given time, it mainly depends on the number of affiliated entities of its lowest rank.

In fact, most of the time, the aim of this type of organisation is to enrich the entities of high levels of the pyramid by means of contributions from entities of lower ranks by hoping that the latter shall one day be situated at the apex of their own pyramid and then benefit from a similar remuneration.

This is the reason why these organisations are frequently illegal. Even in cases where they are tolerated, their main objective is most often diverted, the entities being much more preoccupied with conversion so as to obtain substantial financial gains than to pursue the true objectives of said organisation.

The object of the invention to make use of experience acquired in this field by taking account of the negative aspects previously mentioned so as to design and implement a perennial multifunctional communication network able to be easily managed.

With this aim in mind, it concerns dissociating the problems relating to communication (setting up a communication/navigation network on this network) from problems relating to the exploitation of the network (marketing/remuneration).

With a view to obtaining these results, the method of the invention introduces:

firstly a parent pyramidal structure formed of a multiplicity of validated elementary communication networks with a pyramidal structure, each elementary network comprising a predetermined number of communication nodes and being obtained from the central node of level n which itself creates a predetermined number of secondary communication nodes situated at a lower level n-1, each of these nodes of said level n-1 creating in turn a predetermined number of communication nodes situated at a level n-2, and so on until a level n-m is reached, the number m of levels being fixed at a predetermined value, this elementary network being operational only when it has been validated, each elementary network central node consisting of a secondary node of another network of the parent pyramidal structure, except as regards the central node of the parent pyramidal structure,

secondly, an exchange and communication protocol between the various communication nodes, it being understood that each node is able to communicate with the nodes it has itself directly or indirectly generated at the following levels with the nodes of the same level and with the nodes of the preceding levels by means of the node of the preceding level from which it originates.

Preferably, an elementary network shall be validated only when all its levels including the n-m level are complete.

Advantageously, the method previously described could introduce a network consisting of approved partners accessible from the nodes of the communication network by means of a management interface provided with navigation means, and the management of exchanges between the nodes of the communication network and the approved partners. This network of approved partners could shall include in particular specialists able to equip each of the communication nodes with hardware and software means enabling it to carry out its function. The management interface could particularly manage tasks involving the remuneration of the partners and possibly the communication nodes.

Similarly, said protocol could introduce a navigation tool using a graphic representation of the elementary networks and their links according to which each network is represented in the form of a central node and concentric circles representing successive levels, each concentric circle bearing the secondary communication nodes of the corresponding level and radial links connecting each communication node to the nodes it has itself generated.

One embodiment of the invention shall be described hereafter and given by way of non-restrictive example with reference to the accompanying drawings on which:

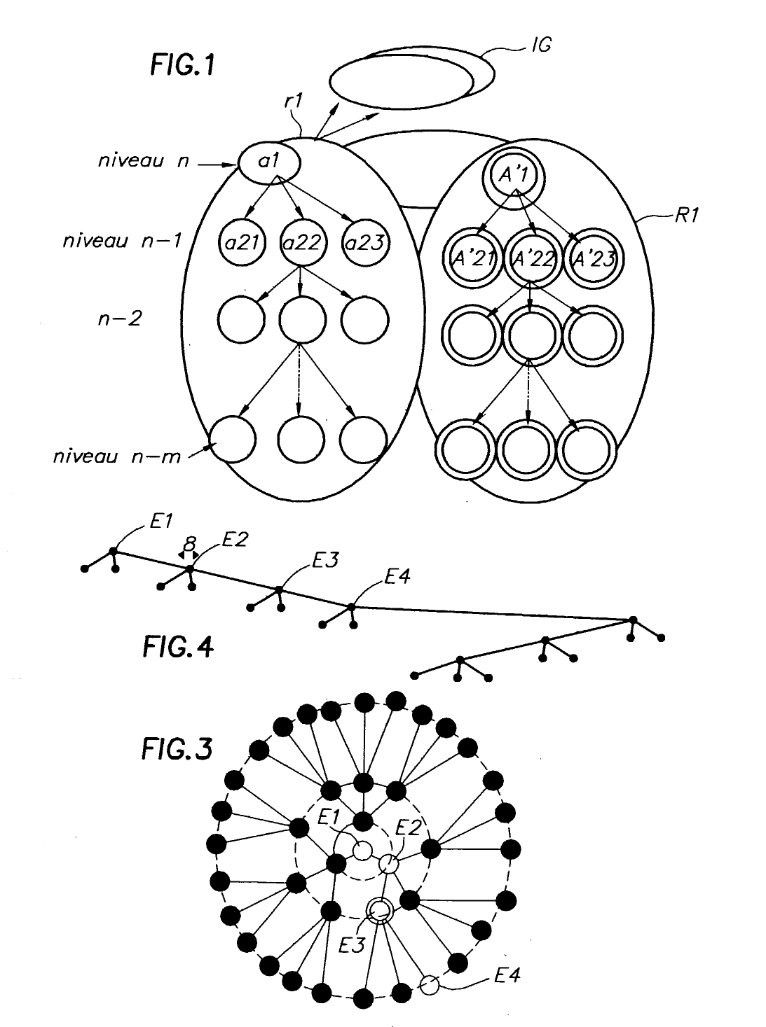

FIG. 1 is a diagrammatical representation of an elementary network at the time it was set up and validated,

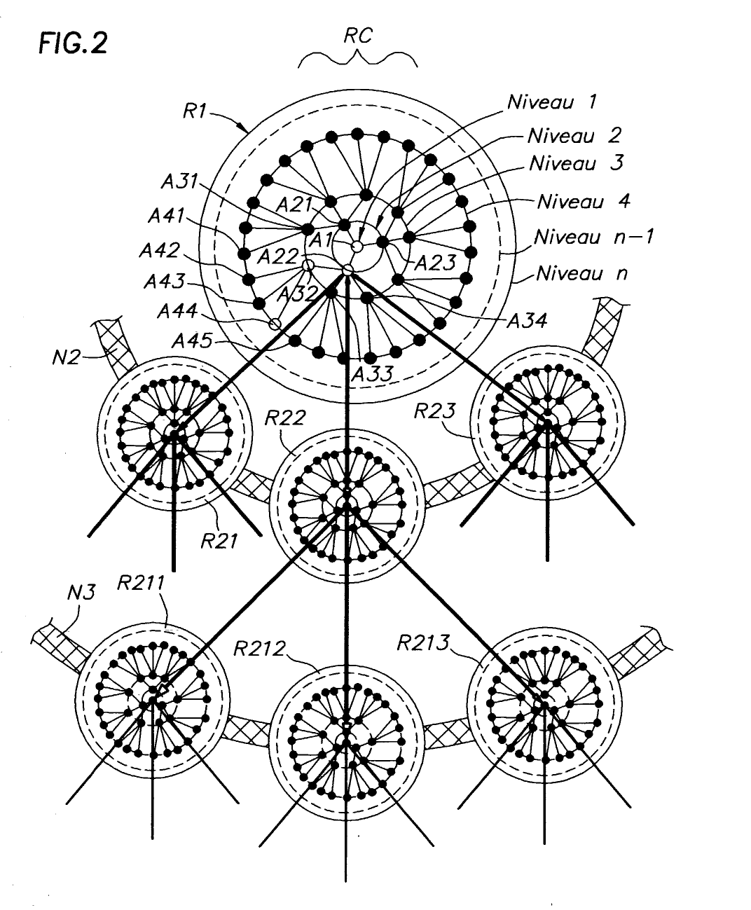

FIG. 2 is a partial graphic representation of a communication network comprising several elementary networks,

FIG. 3 is a graphic representation on larger scale of an elementary network used by the navigation system of the invention,

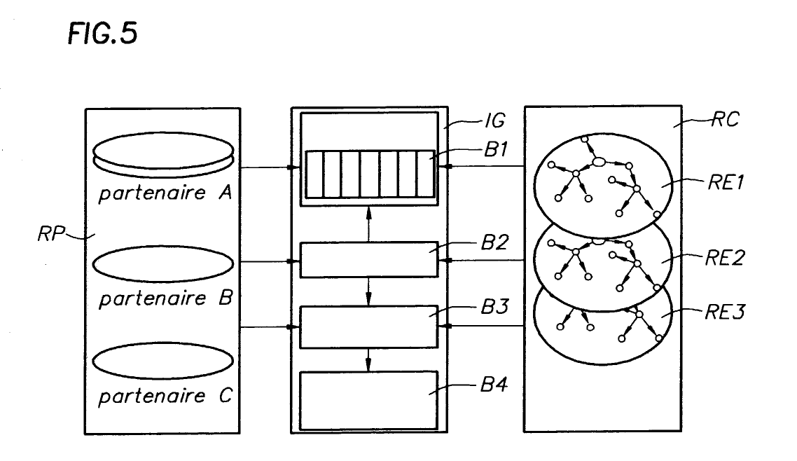

FIG. 4 is a view of a path inside the network according to a conventional three-dimensional representation,

FIG. 5 is a diagrammatical representation of the functional architecture of the system for implementing the method of the invention,

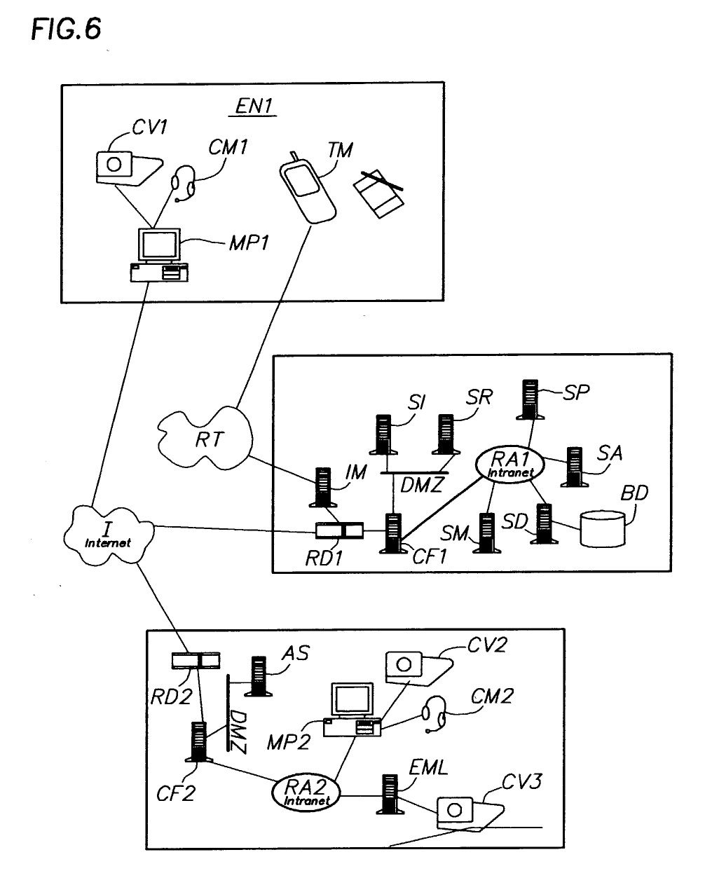

FIG. 6 shows the architecture and hardware means used for implementing the method of the invention.

As previously mentioned, the communication system of the invention uses a communication network RC including a multiplicity of elementary networks, each comprising each a multiplicity of communication nodes able to communicate with one another according to a pre-established protocol depending on their set-up mode.

Each of said elementary networks is constituted from a first central communication node a₁ (level n) according to the following process shown on FIG. 1.

The first node a₁ (level n) generates a limited number of secondary communication nodes, in this instance three nodes a₂₁, a22, a23 belonging to a level n-1.

Each of these secondary nodes a₂₁, a22, a23 in turn creates three new nodes at a level n-2.

The secondary nodes situated nodes situated at level n-2 shall each in turn each create three secondary nodes at a level n-3 (not shown).

This process is repeated until a level n-(m-1) is reached, then a predetermined level n-m, in this instance the level 8.

When the level n-m is complete, the elementary network set up r₁ is validated and its creation process stops. It can thus be integrated with the network RC. On FIG. 1, this elementary network denoted by R₁ thus includes 3280 communication nodes A₁, A₂₁ , A₂₂ , A₂₃ each represented by two concentric circles.

This validation phase is carried out by a management interface IG (FIG. 5) which integrates the new network in a navigation system able to place said 3280 nodes in mutual communication and with a network of approved partners RP.

At the same time, indeed even subsequently, each node of the network R₁ could create one or several affiliated elementary networks, preferably three. Each of said affiliated networks shall only be validated when its eighth level is complete.

This process is shown on FIG. 2 in which each elementary network has been shown in a planetary form according to which the central node constitutes a planet, whereas its secondary nodes (satellites) are placed along m concentric circles each representing a level on which the corresponding nodes are placed.

In this example, the node A₂₂ of the network R₁ (whose central node is designated by A₁) has itself created three elementary networks R₂₁, R₂₂, R₂₃ situated at a level N₂ in relation to the network R₁.

The central node of the network R₂₂ has also created three elementary networks R₂₁₂, R₂₁₃, R₂₁₄ situated at a level N₃.

The levels N₂ and N₃ are represented by concentric circles at the node A₂₂ of the network R₁.

The representation method shown on FIG. 2 is a simplified representation method inside a plane (2D), it being understood that it is possible to use a three-dimensional mode of representation (3D) exploited by a design or computer-assisted drawing software (CAD) best adapted for representing the meshed structure of the network.

Nevertheless, so as to facilitate navigation inside the network, the invention offers a particularly efficient navigation tool using the 2D type of representation described previously.

Following identification and validation of a node of the network, this tool is able to display on a screen the planetary structure whose central node consists of the node which has been validated and whose satellite nodes are placed on concentric circles representative of subjacent levels, these satellite nodes being interconnected and to the central node by links corresponding to wire frame telephone connections between the nodes (see FIG. 3).

From this planetary structure shown on the screen, the navigator can, by clicking on one of the nodes of the structure, obtain again a new planetary structure centered on the node which he had just clicked.

By repeating this process, the navigator can reach the searched node and can therefore communicate with the entity associated with this node.

Advantageously, the navigation system could then memorise the path taken so as to reach this node and give a representation in three-dimensional mode of the type of the one shown on FIG. 4 which only includes the nodes borrowed by the path, as well as the directly affiliated nodes.

Following the request of a duly empowered entity which wishes to access an identified node, this navigator can be possibly offered and specific optimised path observing the communication protocol used by the system and taking account of the effectiveness of this path (which depends on the quality of the nodes and borrowed links).

It ought to be borne in mind that according to the protocol, each entity can, for example, communicate with the entities of the same level and with entities of lower levels and with the higher ranked entity from which it originates and by means of this entity of high rank it can communicate with other entities situated at said higher rank.

More specifically, the entity wishing to communicate with another entity could use a set of navigation tools for:

visualising fully or partially the zone of the network to the extent that it is authorised to access this zone, and/or

zooming on a node and obtain all the entities affiliated to it in the lower levels, and/or

obtain information concerning the selected node (private information if authorised, information, on all the nodes affiliated to it, statistical information, financial information), and/or

changing the method for representing the selected network (for example passage from a 3D representation to a 2D representation) by clicking on a button.

Moreover, the navigation system could associate with a graphic representation of all or part of the network information relating to the effectiveness of various branches and the path the entity can borrow.

In the example represented on FIG. 3, the nodes E₁ to E₄ shown in white by circles defining a path whose effectiveness is altered owing to the presence of a deficient node E₃ indicated by a double circle.

In the case where a defective node is clicked, such as the node E₃, the system gives information concerning the reasons why this node is no longer efficient and the nature of the defects. It can also display information concerning the consequences of these defects concerning communications passing through this node and supply information required to determine a bypass path.

As previously mentioned, the system of the invention moreover uses a network of approved partners RP accessible from the nodes of the communication network by means of a management interface equipped with navigation and exchange management means between the nodes of the network and the approved partners.

As shown on FIG. 5, this management interface IG could ensure the functions of a server and administrator and network exchange manager, both as regards the communication network RC (which can for example use the Internet network) and the network (for example Intranet) linking the various approved partners.

It could take charge of the navigation problems inside these networks, the determination of the statistical and graphical data used at the level of the nodes, the management of collaborations, and tasks involving administration and the management of exchanges.

This interface can moreover take charge of the organisation of mail, discussions and forums, videoconferences and generally speaking transmissions of information and protection linked to these transmissions. It could ensure the management of purchases, payments and the remuneration of entities allocated to said communication nodes.

It could also manage the hardware and software maintenance of resources used by the nodes of the network and possibly provide an on-line assistance in the direction of the network.

The purpose of this interface is to facilitate communication between all the nodes of the network, as well as between said nodes and the network of partners by using all conventional means of communication available on the market and by interfering as little as possible concerning communications.

The interface could advantageously take charge of the supply and maintenance of the hardware and software equipping the communication nodes, it being understood that the effectiveness of the communications made within the network largely depending on the homogeneity and compatibility of the hardware and software used by said networks.

These functions are diagrammatically represented on FIG. 5 in which the network RC is indicated by a block containing several elementary networks RE₁, RE₂, RE₃.

This network communicates with a network of approved partners (also represented by a block AP) comprising a plurality of partners (partner A, partner B, partner X) by means of a management interface IG.

This management interface IG implements four main administration functions, namely:

the management and organisation of communications (audio transmissions, video, organisation of meetings, forums, discussions, mail management) (block B₁),

the taking charge of entities allocated to the communications nodes of the network RC (subscription, identification, protection) (block B₂),

the navigation in the networks RC and RP with zooming possibility and supply of statistical data, management of invoices and remunerations (block B₃),

management of the network RP (Intranet) (block B₄).

The means implemented by the communication system previously described could use, as shown on FIG. 6:

A) a set EN₁ of means for equipping the entities constituting the nodes of the communication network R₁, this first set of means able to comprise firstly fixed local units each comprising a multimedia type microcomputer MP₁ connected to the Internet network I and to which various terminals can be connected, such as a camera CV₁, microphone/loudspeaker headset CM₁ allowing audio/video communications, and secondly mobile equipment, such as mobile telephone or similar devices TM using the wired or cellular telephone network RT.

B) A first Intranet network RA₁ organised at the level of the management interface IG and to which connected is a plurality of servers, said Intranet network RA₁ being connected to an Internet network I by means of a fire-cutter circuit CF₁ or a router RD. This router RD is used to connect the connected entities to the Internet network I and the taking into account of all the TCP/TP communications between the Internet network I and the external world. In this example, it is further connected to a hardware/software interface IM which is used for managing communications between the telephone network RT and the Internet I and Intranet RA₁ networks. The fire-cutter CF₁ is hardware /software equipment for protecting the network RA₁ from the external world. It comprises a DMZ network comprising a branch which constitutes a demilitarized zone and a buffer area possibly including an Internet server used as an intermediary for an Internet gate server.

In this example, the DMZ network is connected firstly to a hardware and software equipment SI able to adapt Internet messages to the WAP type mobile terminals, and secondly to a hardware and software equipment SR handling all the requests originating from the external world. In particular, said equipment SR is used as an interface between the requests derived from the external world and the Intranet network RA₁ as regards questions on protection.

A plurality of servers is connected to the Intranet network RA₁, namely:

a gate server SP,

a protocol server SA for access to the entities of the network,

a data server SD associated with a data base BD,

a collaboration server SM.

The gate server SP constitutes the main input for all the services and information on the Intranet network. It has available all he infonnation and services at a location accessible to the public or only to a duly identified specific population. It is a location where the duly approved persons have their own workstations and are able to use any type of collaboration tools placed at their disposal.

The access protocol service SA for accessing the entities of the network RI is required so as to supply a directory of all the entities interacting inside the entire communication network RI, as well as any kind of information and dedicated services.

The collaboration server SM is hardware/software equipment used to supply asynchronous collaboration (email, calendar, forum, list of tasks, new) and a synchronous collaboration (debates, audio/video conferences, application sharing, blackboard . . . )

The data server SD is hardware and software equipment used for managing a data base for all the information used by the gate server SP and the collaboration server SM.

C) A second Intranet network RA₂ allocated to the approved partner network RP which is connected to the Internet network I by means of fire-cutter CF₂ and a router RD₂ whose roles are similar to those of the fire-cutter CF₁ and the router RD₁. The fire-cutter CF₂ is connected to a network DMZ similar to the previous one to which connected is a server AS placed at the disposal of the entities of the network R₁ so as to provide them with assistance, information, and services. Of course, each partner of the network RP could be connected to the Intranet network RA₂ by means of local units able to each comprise a microcomputer MP₂ equipped with a camera CV₂, a micro/loudspeaker headset CM₂ allowing audio/video communications. Each of said local units could be equipped with a virtual gallery for displaying products and/or the services for the entities of the network R₁.

Moreover, the Intranet network RA₂ could be connected to one or several hardware/software items of equipment EMI for controlling the audio/video communications between the virtual galleries of the approved partners and entities of the network RI and wishing to have additional information on the products and services supplied by the approved partners. These items of equipment could include video cameras CV₃ for displaying products and illustrating services.

Of course, the invention is not limited to this embodiment. In particular, the Intranet and Internet networks could be replaced by equivalent networks without modifying the principle of the invention.

1. Method for setting up and implementing a multifunctional communication network (RC), characterised in that it implements:
firstly, a parent pyramidal structure formed of a multiplicity of validated communication networks (R₁), each having a planetary network with a pyramidal structure comprising a predetermined number of communication nodes (A′¹, A′₂₁, A′₂₃), said planetary network being obtained from a central node (A′₁) of levels n which in turn creates a predetermined number of secondary communication nodes (A′₂₁, A′₂₂) of level n-1, each node of n-1 level constituting in turn a predetermined number of communication nodes of level n-2 and so on until a level n-m is reached, said elementary network (R₁) being put into service solely after it is validated, each central node (A′¹) consisting of a secondary node of another elementary network, except as regards the central node of the parent structure,
secondly, an exchange and communication protocol between the various communication nodes (A′₁, A₂₁ , A′₂₂), a protocol according to which each node (A′₁) is able to communicate with the nodes (A′₂₁, A′₂₂, A′₂₃) which in turn it has directly or indirectly created at the following levels n-1 with the nodes of the same level n and with the nodes of the preceding level by means of the node of the preceding level from which it originates.

2. Method according to claim 1, characterised in that the validation of an elementary network (R) is carried out only when all its levels including the level n-m are complete.

3. Method according to claims 1 or 2, characterised in that the said protocol introduces a navigation tool implementing a planetary type graphical representation of the elementary networks in the form of a central node (E₁) and concentric circles representing said levels, each concentric circle bearing the secondary communication nodes belonging to this level and radial links linking each communication node to the nodes it has itself created, each node being able to communicate with the nodes it has itself created with the following levels and with the nodes of the preceding levels by means of a node of the preceding level from which it originates.

4. Method according to one of the preceding claims, characterised in that it uses an approved partner network (RP) able to be accessed from the nodes of the communication network (RC) by means of a management interface (IG) equipped with navigation and exchange management means between the nodes of the communication network and the approved partners.

5. Method according to claim 4, characterised in that said management interface (IG) implements the following administrative functions:
the management and organisation of communications (audio, video transmissions, organisation of meetings, forums, discussions, mail management) (block B₁),
the taking in charge of entities allocated to the communication nodes of the network (RC) (subscription, identification, security) (block B₂),
the navigation in the network (RC) and the network (RP) with the possibility of zooming and supplying statistical data, management of invoices and payments (block B₃),
management of the network (RP) (Intranet) (block B₄).

6. Method according to claim 4, characterised in that the approved partner network (RP) is an Intranet type network.

7. Method according to one of the preceding claims, characterised in that the nodes of said pyramidal structures intercommunicate on the Internet network.

8. Method according one of claims 3 to 7, characterised in that said navigation tool associates with the partial representation of the network (RC) information relating to the efficiency of the various branches and paths the entity can borrow.

9. Method according of one of claims 3 to 7, characterised in that said navigation tool makes it possible to obtain, following identification and validation of a node of the network (E₁) appearing in said graphical representation, a new planetary type graphical representation in which the central node consists of the node (E₁) which has been validated, this process being able to be repeated until the sought-after node is obtained.

10. Method according to claim 9, characterised in that the navigation system stores the borrowed path to reach said sought-after node so as to make a representation only including the nodes (E₁, E₂, E₃, E₄) borrowed by the path, as well as the directly affiliated nodes.

11. Method according to one of claims 3 to 10, characterised in that following the request of a duly approved entity wishing to access an identified node, the navigation system determines and offers said entity an optimised path observing said communication protocol and taking account of the efficiency of said path.

12. Method according to one of the preceding claims, characterised in that said navigation system comprises a set of navigation tools making possible to:
display fully or partly the area of the network to the extent that it is authorised to access this area, and/or
to zoom on a node and obtain all the entities affiliated to it in the lower levels, and/or
obtain information concerning the selected node, and/or
change the mode of representation of the selected network (for example pass from a 3D representation to a 2D representation) by clicking on a button.

13. System for implementing the method according to one of the preceding claims, characterised in that it includes:
a set (EN₁) of means to equip the entities constituting the nodes of the communication network (R₁), this first set of means comprising firstly fixed local units each comprising a multimedia type microcomputer (MP₁) connected to an Internet network (I) and/or secondly mobile equipment, such as mobile telephones or similar devices (TM) using the wire-frame or cellular telephone network (RT),
a first Intranet network (RA₁) organised at the level of the management interface (IG) and on which connected is a plurality of servers, this Intranet network (RA₁) being connected to the Internet network (I) by means of a fire-cutter circuit (CF₁) and a router (RD₁),
a second Intranet network (RA₂) allocated to the approved partner network (RP) which is connected to the Internet network (I) by means of a fire-cutter (CF₂) and a router (RD₂) whose roles are similar to those of the fire-cutter (CF₁) and the router (RD₁).
